(19) United States
(12) Patent Application Publication
(10) Pub. No.: US 2024/0240666 A1
(43) Pub. Date: Jul. 18, 2024

(54) EXPANDABLE TIMING WASHER

(71) Applicant: Swiss CNC, LLC, Montgomery, TX (US)

(72) Inventors: Christopher Steven Adams, Montgomery, TX (US); Donny Michael Byrne, Montgomery, TX (US)

(21) Appl. No.: 18/411,999

(22) Filed: Jan. 12, 2024

Related U.S. Application Data
(60) Provisional application No. 63/438,747, filed on Jan. 12, 2023.

(51) Int. Cl. F16B 43/00

(52) U.S. Cl. CPC F16B 43/009

(57) ABSTRACT

An expandable washer includes a first washer piece comprising a first plurality of steps arranged about a first helical ramp, and a second washer piece comprising a second plurality of steps arranged about a second helical ramp and configured so that at least one step of the second plurality of steps matingly abuts at least one step of the first plurality of steps when the second washer piece is inserted into the first washer piece.

### CROSS-REFERENCE TO RELATED APPLICATIONS

This patent application claims priority from, and incorporates by reference the entire disclosure of, U.S. Provisional Application No. 63/438,747 filed on Jan. 12, 2024.

### TECHNICAL FIELD

The present disclosure relates generally to washers and more particularly, but not by way of limitation, to an expandable timing washer.

### BACKGROUND

This section provides background information to facilitate a better understanding of the various aspects of the disclosure. It should be understood that the statements in this section of this document are to be read in this light, and not as admissions of prior art.

When using a fastener, such as a bolt or screw, a washer is often positioned between a head of the fastener and an object being secured by the fastener. Washers can serve several purposes, such as distributing the load from the fastener to a larger area and to help prevent the fastener from loosening. In some instances, washers may be used as spacers or shims to help locate an object in a desired position. For example, it maybe desirable for a washer to have specific thickness so that the object being fastened has a specific position (e.g., position could include one or both of an axial and a radial position). While washers can help position or space objects as desired, they do not allow precision when doing so.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

According to aspects of the disclosure, an expandable washer includes a first washer piece comprising a first plurality of steps arranged about a first helical ramp, and a second washer piece comprising a second plurality of steps arranged about a second helical ramp and configured so that at least one step of the second plurality of steps matingly abuts at least one step of the first plurality of steps when the second washer piece is inserted into the first washer piece.

In some aspects, the expandable washer further includes a marker located on the first washer piece that provides indexing information.

In some aspects, the marker is an indentation.

In some aspects, the expandable washer includes a marker located on the second washer piece that provides indexing information.

In some aspects, when the second washer piece is inserted into the first washer piece, opposing axial faces of the expandable washer are normal to a central axis of the expandable washer.

In some aspects, the second washer piece comprises at least one step that has a different shape than steps of the second plurality steps.

In some aspects, the expandable washer is configured so that an axial thickness of the expandable washer may be changed by rotating the second washer piece relative to the first washer piece to change which steps of the second plurality of steps engage which steps of the first plurality of steps.

In some aspects, the first and second pluralities of steps are arranged so that a face of each step is normal to a central axis of the expandable washer.

In some aspects, the first and second pluralities of steps are arranged so that a face of each step is angled relative to a central axis of the expandable washer.

According to aspects of the disclosure, a method of changing a thickness of an expandable washer includes rotating a first washer piece relative to a second washer piece to change which steps of a first plurality of steps of the first washer piece engage which steps of a second plurality of steps of the second washer piece, each plurality of steps being arranged on a helical ramp.

In some aspects, the first washer piece further comprises a marker that provides indexing information.

In some aspects, the marker is an indentation.

In some aspects, the second washer piece further comprises a marker located on the second washer piece that provides indexing information.

In some aspects, the rotating comprises rotating the first washer piece to align the marker of the first washer piece with the marker of the second washer piece.

In some aspects, when the second washer piece is inserted into the first washer piece, opposing axial faces of the expandable washer are normal to a central axis of the expandable washer.

In some aspects, the second washer piece comprises at least one step that has a different shape than steps of the second plurality steps.

In some aspects, the first and second pluralities of steps are arranged so that a face of each step is normal to a central axis of the expandable washer.

In some aspects, the first and second pluralities of steps are arranged so that a face of each step is angled relative to a central axis of the expandable washer.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 is a perspective view of an expandable timing washer, according to aspects of the disclosure;

FIGS. 2A and 2B are side views of an expandable timing washer in a collapsed and an extended configuration, respectively, according to aspects of the disclosure;

FIG. 3 is a perspective view of an expandable timing washer in an extended configuration, according to aspects of the disclosure;

FIGS. 4A and 4B are perspective and side views, respectively, of a first washer piece, according to aspects of the disclosure; and

FIGS. 5A and 5B are perspective and side views, respectively, of a second washer piece, according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure. However, it should be noted that the disclosure below is for illustrative purposes only and is not intended to limit the scope of the claimed subject matter in any way.

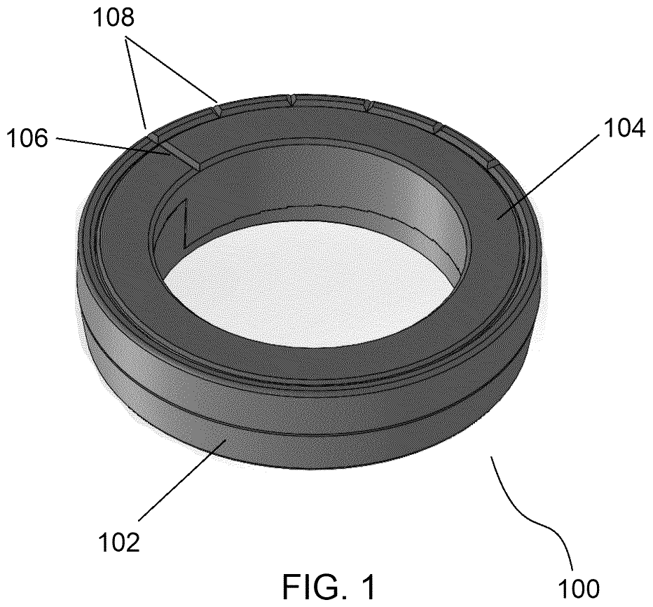

In some instances, it is desirable to be able to set a thickness of a washer, for example when clocking a muzzle device to a barrel at a set alignment. Clocking refers to a deliberate setting of the positioning of a component relative to another component. For example, the positioning may be a radial and/or axial position of the component. Conventionally, this would be accomplished by using one or more washers or shims to achieve the desired clocking. Clocking in this manner can be quite difficult. In some instances, the size of the washers or shims are not appropriate to achieve the desired clocking. In some instances, washers may deform or the torque applied to a fastener may be unrepeatable to achieve the desired clocking. To more precisely and repeatably set the clocking, an expandable timing washer 100 of FIG. 1 may be used.

Expandable timing washer 100 is configured such that a thickness of washer 100 can precisely adjusted by “timing” or “clocking” components of washer 100. Washer 100 includes a first washer piece 102 and a second washer piece 104 that fits concentrically within first washer piece 102. The height of washer 100 is adjusted by rotating (e.g., “timing”) second washer piece 104 relative to first washer piece 102. Each of washer pieces 102, 104 includes a plurality of steps that are configured to matingly abut one another. Each step of the plurality of steps is arranged on a helical ramp so that an axial height of washer 100 can be changed. In some aspects, first washer piece 102 includes one or more markers 106 and second washer piece 104 includes one or more markers 108. Markers 106, 108 provide a visual indication of the radial alignment of first washer piece 102 relative to second washer piece 104. This allows a user to easily index washer pieces 102, 104 in a repeatable and certain amount. In some aspects, markers 106, 108 are indentations or groves formed into washer pieces 102, 104. In other aspects, markers 106, 108 may take other forms such as colored dots, numbers, raised marks (bumps, tick marks, etc.).

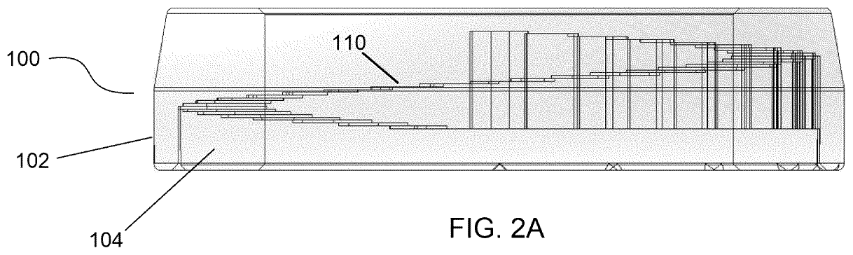

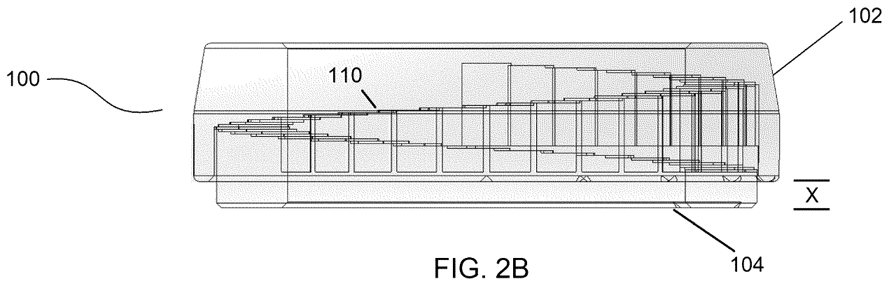

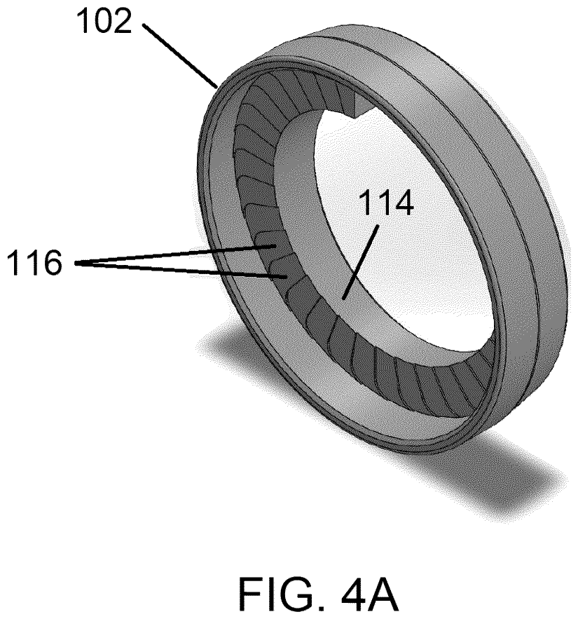

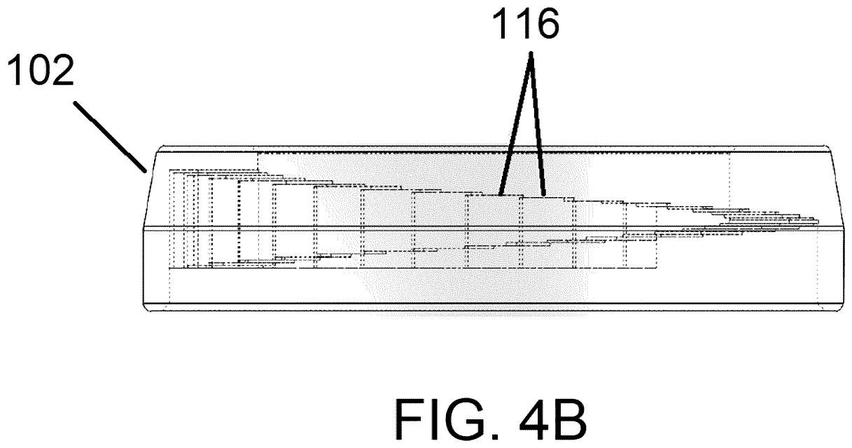

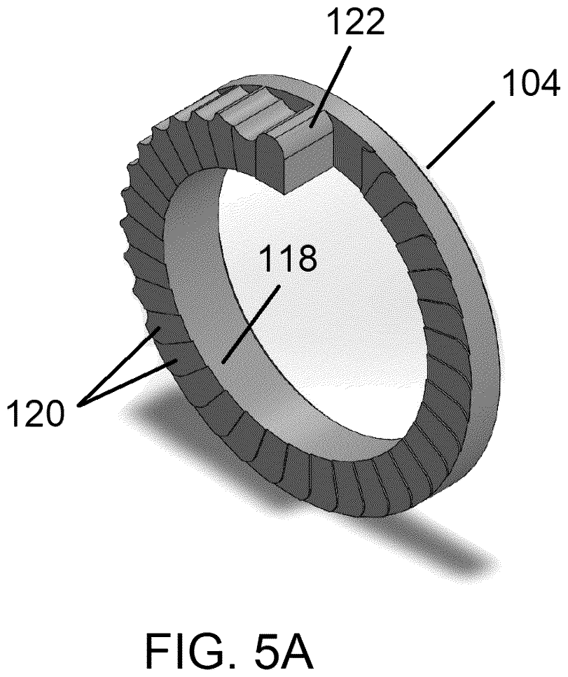

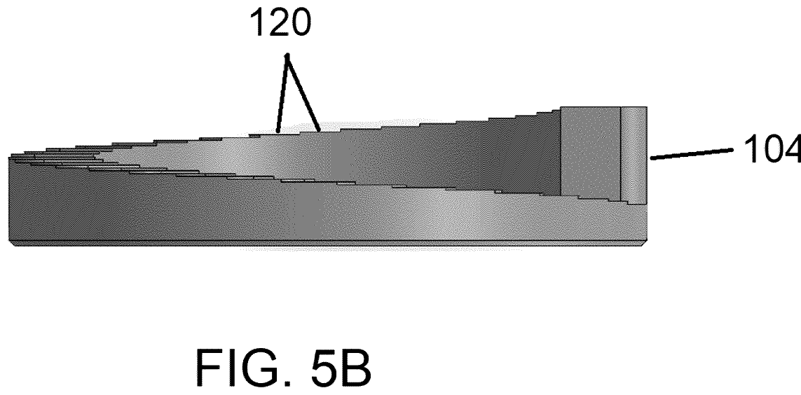

Referring now to FIGS. 2A and 2B, side views of expandable timing washer 100 in a collapsed and an extended configuration, respectively, are shown. In FIGS. 2A and 2B washer pieces 102, 104 have been made transparent to better show the interface between washer pieces 102, 104. In FIG. 2A, washer 100 is in a collapsed position. In the collapsed position, washer 100 is in its thinnest configuration withe washer piece 104 completely nested within washer piece 102. Each of washer pieces 102, 104 includes a plurality of steps (see steps 116, 120 in FIGS. 4A, 4B, 5A, 5B) that are configured to follow a helical path 110. In FIG. 2B, washer piece 104 has be rotated or “clocked” relative to washer piece 102 to increase an axial thickness of washer 100. The increase in axial thickness is designated as “X” in FIG. 2B. The magnitude of X is dependent upon the amount of rotation of washer piece 104 relative to washer piece 102. The number of steps 116, 120 and the pitch of helical path 110 dictates how much the axial thickness changes with each incremental turn of washer piece 104. It will be appreciated that the number of steps 116, 120 and the pitch of helical path 110 may be varied for different applications. For example, incremental changes in axial thickness may be increased by increasing the pitch of helical path 110 or reducing the number of steps 116, 120. Incremental changes in axial thickness may be decreased by decreasing the pitch of helical path 110 or increasing the number of steps 116, 120.

As shown in FIGS. 2A and 2B, washer pieces 102, 104 are configured so that the axially opposed faces of washer 100 are normal relative to the central axis of washer 100. This configuration helps washer 100 sit flush when in use. In other aspects, one or both of the axially opposed faces could be configured to be frustoconical, which is beneficial in some applications.

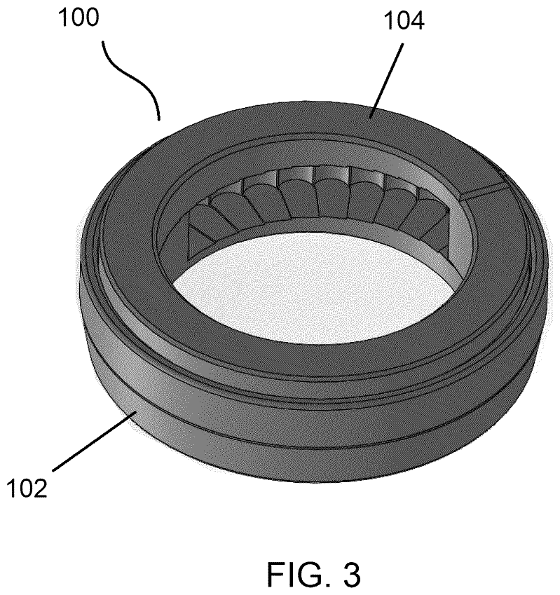

FIG. 3 is perspective view of washer 100 in an extended position, similar to that of FIG. 2B. In FIG. 3, washer piece 104 has been clocked relative to washer piece 102 by 11 steps. The clocking of washer piece 104 in this way creates an opening 112.

FIGS. 4A and 4B are perspective and side views of washer piece 102. In FIG. 4B, washer piece 102 is shown transparent to better illustrate the configuration thereof. Washer piece 102 includes a plurality of steps 116 arranged along helical ramp 114. In some aspects, the plurality of steps 116 are arranged to be normal to the central axis of washer piece 102. In some aspects, the plurality of steps 116 are arranged at an angle relative to the central axis of washer piece 102. Angling the plurality of steps 116 can help with engagement between washer pieces 102, 104. As shown in FIG. 4A, the plurality of steps 116 are recessed within washer piece 102 so that washer piece 104 is concentrically located within washer piece 102, which helps to secure and locate washer piece 104 relative to washer piece 102.

FIGS. 5A and 5B are perspective and side views of washer piece 104. In FIG. 5B, washer piece 104 is shown transparent to better illustrate the configuration thereof. Washer piece 104 includes a plurality of steps 120 arranged along helical ramp 118. In some aspects, the plurality of steps 120 are arranged to be normal to the central axis of washer piece 104. In some aspects, the plurality of steps 120 are arranged at an angle relative to the central axis of washer piece 104. Angling the plurality of steps 120 can help with engagement between washer pieces 102, 104. As shown in FIG. 5A, the plurality of steps 120 terminate with steps 122. Steps 122 comprise a shape that different than steps 120. This shape helps limit the available clocking between washer pieces 102, 104, as over-clocking pieces 102, 104 may result in instability or failure.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. An expandable washer comprising:
a first washer piece comprising a first plurality of steps arranged about a first helical ramp; and
a second washer piece comprising a second plurality of steps arranged about a second helical ramp and configured so that at least one step of the second plurality of steps matingly abuts at least one step of the first plurality of steps when the second washer piece is inserted into the first washer piece.

2. The expandable washer of claim 1, further comprising a marker located on the first washer piece that provides indexing information.

3. The expandable washer of claim 2, wherein the marker is an indentation.

4. The expandable washer of claim 1, further comprising a marker located on the second washer piece that provides indexing information.

5. The expandable washer of claim 1, wherein when the second washer piece is inserted into the first washer piece, opposing axial faces of the expandable washer are normal to a central axis of the expandable washer.

6. The expandable washer of claim 1, wherein the second washer piece comprises at least one step that has a different shape than steps of the second plurality steps.

7. The expandable washer of claim 1, wherein the expandable washer is configured so that an axial thickness of the expandable washer may be changed by rotating the second washer piece relative to the first washer piece to change which steps of the second plurality of steps engage which steps of the first plurality of steps.

8. The expandable washer of claim 1, wherein the first and second pluralities of steps are arranged so that a face of each step is normal to a central axis of the expandable washer.

9. The expandable washer of claim 1, wherein the first and second pluralities of steps are arranged so that a face of each step is angled relative to a central axis of the expandable washer.

10. A method of changing a thickness of an expandable washer, the method comprising:
rotating a first washer piece relative to a second washer piece to change which steps of a first plurality of steps of the first washer piece engage which steps of a second plurality of steps of the second washer piece, each plurality of steps being arranged on a helical ramp.

11. The method of claim 10, wherein the first washer piece further comprises a marker that provides indexing information.

12. The method of claim 11, wherein the marker is an indentation.

13. The method of claim 11, wherein the second washer piece further comprises a marker located on the second washer piece that provides indexing information.

14. The method of claim 11, wherein the rotating comprises rotating the first washer piece to align the marker of the first washer piece with the marker of the second washer piece.

15. The method of claim 10, wherein when the second washer piece is inserted into the first washer piece, opposing axial faces of the expandable washer are normal to a central axis of the expandable washer.

16. The method of claim 10, wherein the second washer piece comprises at least one step that has a different shape than steps of the second plurality steps.

17. The method of claim 10, wherein the first and second pluralities of steps are arranged so that a face of each step is normal to a central axis of the expandable washer.

18. The method of claim 10, wherein the first and second pluralities of steps are arranged so that a face of each step is angled relative to a central axis of the expandable washer.
